(19) United States
(12) Patent Application Publication
(10) Pub. No.: US 2006/0086225 A1
(43) Pub. Date: Apr. 27, 2006

(54) Miter saw

(76) Inventor: Wang Xin, Suzhou (CN)

Correspondence Address: TRASK BRITT, P.O. BOX 2550, SALT LAKE CITY, UT, 84110, US

(21) Appl. No.: 11/186,584

(22) Filed: Jul. 21, 2005

(30) Foreign Application Priority Data
Jul. 26, 2004 (CN) 200420078151.0

(51) Int. Cl. B26D 5/08

(52) U.S. Cl. 83/581

(57) ABSTRACT

The present invention relates to a miter saw and comprises a base, a worktable pivotally mounted on the base, a saw assembly pivotally connected to the worktable, a main fence fixed on the base and straddling the worktable and an auxiliary fence. The main fence includes a first workpiece-abutment surface and the auxiliary fence includes a second workpiece-abutment surface located in substantially the same plane as the first workpiece-abutment surface. The main fence includes at least one female connecting member and the auxiliary fence includes at least one male connecting part such that the male connecting part is selectively interconnected with the female connecting member. The male connecting part is selectively interconnected with the female connecting members such that the auxiliary fence is easily movable relative to the main fence. The present invention provides an easily-operated, simply constructed fence assembly for a miter saw.

### BACKGROUND OF THE INVENTION

1. Field of the Invention

The invention relates to a power tool (e.g., a desk-top power tool) in particular to a miter saw with a novel fence assembly.

2. State of the Art

Desktop miter saws are widely used for cutting workpieces. The miter saw generally comprises a base, a worktable pivotally mounted on the base, a fence assembly mounted on the worktable and a saw assembly pivotally connected to the worktable. The fence assembly generally includes a main fence fixed on the worktable and an auxiliary fence. The auxiliary fence may have various configurations by being slidingly or pivotally attached to the main fence. U.S. Pat. No. 5,297,463 discloses a miter saw having a sliding auxiliary fence. The auxiliary fence can slide relative to a main fence to avoid interference with a saw assembly. The miter saw comprises a locking mechanism to secure the auxiliary fence to the main fence. The manual operation of the locking mechanism before or after the auxiliary fence slides is an unavoidable but complex step. Moreover the cost of manufacturing the sliding auxiliary fence is quite high.

### BRIEF SUMMARY OF THE INVENTION

It is an object of the present invention to provide a miter saw including a straightforwardly constructed fence assembly to overcome the drawbacks of the fence assembly of a conventional miter saw.

An embodiment of the miter saw of the present invention for cutting a workpiece comprises a base, a worktable pivotally mounted on the base, a saw assembly pivotally attached to the worktable, a main fence fixedly mounted on the base and straddling the worktable and an auxiliary fence. The main fence includes a first workpiece-abutment (or supporting) surface and the auxiliary fence includes a second workpiece-abutment (or supporting) surface substantially coplanar with the first workpiece-abutment surface. The main fence includes at least one female connecting member and the auxiliary fence includes at least one male connecting part (or member) such that the male connecting part is selectively interconnected with the female connecting member.

In a preferred embodiment, the miter saw comprises

a base;

a worktable which is pivotally mounted axially on the base, the worktable defining a rotary support surface for supporting the workpiece;

a saw assembly pivotally connected substantially tangentially to the worktable, the saw assembly including a cutting element which is pivotal along a path between a cutting position at the support surface and a non-cutting position remote from the support surface;

a main fence fixed to the base and straddling the worktable, wherein the main fence includes a first workpiece-abutment surface and a connecting member; and

an auxiliary fence including a second workpiece-abutment surface and a connecting part interengaged with the connecting member whereby the main fence and the auxiliary fence are juxtaposed so that the first workpiece-abutment surface and the second workpiece-abutment surface are substantially coplanar and define a gap through which the path between the cutting position and the non-cutting position extends uninterrupted.

Preferably, the cross-section of the gap is a truncated V-shape. The gap is preferably defined by a truncated rectangular pyramidal cut-away portion.

The main fence and auxiliary fence typically have a substantially rectangular cross-section. The auxiliary fence may be a two-part fence. A first fence part may be mounted on the main fence spaced apart from a second fence part mounted on the main fence. The leading edge of the first fence part and the leading edge of the second fence part may be tapered (e.g., to define a gap with a V-shaped cross section therebetween).

The male connecting part disposed on the auxiliary fence may be selectively interconnected with the female connecting member disposed on the main fence such that the auxiliary fence is easily movable relative to the main fence. The fence assembly is easily operated and straightforwardly constructed.

Preferably, the connecting member is one of a plurality of connecting members, wherein more than one of the plurality of connecting members is selectively interengageable with the connecting part so that the first workpiece-abutment surface and the second workpiece-abutment surface define a variable gap. The variable gap advantageously accommodates the saw assembly disposed either for cutting a workpiece square or at an angle without interfering with the cutting action.

Preferably, the connecting part is one of a plurality of connecting parts, wherein more than one of the plurality of connecting parts is selectively interengageable with the connecting member so that the first workpiece-abutment surface and the second workpiece-abutment surface define a variable gap. The variable gap advantageously accommodates the saw assembly disposed either for cutting a workpiece square or at an angle without interfering with the cutting action.

Preferably, the connecting member is one of a plurality of connecting members and the connecting part is one of a plurality of connecting parts, wherein each of more than one of the plurality of connecting members is selectively interengageable with each of more than one of the connecting parts so that the first workpiece-abutment surface and the second workpiece-abutment surface define a variable gap. The variable gap advantageously accommodates the saw assembly disposed either for cutting a workpiece square or at an angle without interfering with the cutting action.

Preferably, the connecting part is a male connecting part and the connecting member is a female connecting member.

Preferably, the female connecting member is a recess or aperture disposed on the top surface of the main fence.

Preferably, the male connecting part is a fastener (such as a bolt) projecting downwardly from the base of the auxiliary fence and inserted into the corresponding recess. Particularly preferably, the fastener is of approximately the same diameter as the recess.

In a preferred embodiment, the miter saw for cutting a workpiece comprises a base and a worktable pivotally mounted-on the base. A saw assembly is pivotally connected to the worktable. A main fence is fixedly connected to the base and straddles the worktable and includes a first workpiece-supporting surface. An auxiliary fence includes a second workpiece-supporting surface, coplanar with the first workpiece-supporting surface. The main fence comprises at least one female connecting member. The auxiliary fence includes at least one male connecting members. The male connecting member is selectively interconnected with the female connecting member.

Preferably, the female connecting member is a recess disposed on the top surface of the main fence.

Preferably, the male connecting member is a bolt projecting downwards from the bottom surface of the auxiliary fence so as to be inserted into the corresponding recess.

Preferably, the bolt is of approximately the same diameter as the recess.

The present invention will now be illustrated in a non-limitative manner with reference to the following detailed description of a preferred embodiment and the accompanying drawings.

### BRIEF DESCRIPTION OF THE SEVERAL VIEWS OF THE DRAWINGS

FIG. 1 is a perspective view of a miter saw according to a preferred embodiment of the present invention;

FIG. 2 is a top view of the miter saw shown in FIG. 1 with the saw assembly removed;

FIG. 3 is a left view of the miter saw shown in FIG. 2;

FIG. 4 is an isolated view of the auxiliary fence of the miter saw shown in FIG. 1;

FIG. 5 is a left view of the auxiliary fence shown in FIG. 4;

FIG. 6 is a sectional view along direction A-A in FIG. 2; and

FIG. 7 corresponds to the view illustrated in FIG. 6 with the auxiliary fence in a different selected position.

### DETAILED DESCRIPTION OF THE INVENTION

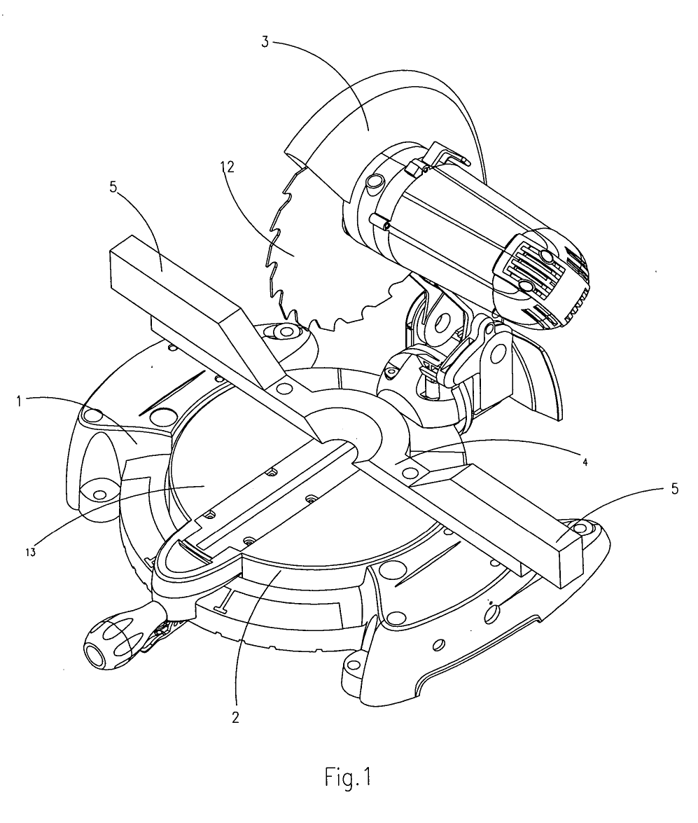

Referring to FIG. 1, a preferred embodiment of the present invention is a miter saw comprising a base 1, a worktable 2 pivotally mounted on the base 1, a saw assembly 3 pivotally connected to the worktable 2 and a fence assembly. The fence assembly includes a main fence 4 fixedly mounted on the base 1 and freely straddling the worktable 2 and a pair of spaced apart auxiliary fences 5. The saw assembly 3 comprises a rotary saw blade 12 driven by a motor (not shown) for square and/or angular cutting of a workpiece (not shown) which is located on a working surface 13 of the worktable 2. The saw assembly 3 can be rotated relative to the worktable 2 to perform angular cutting.

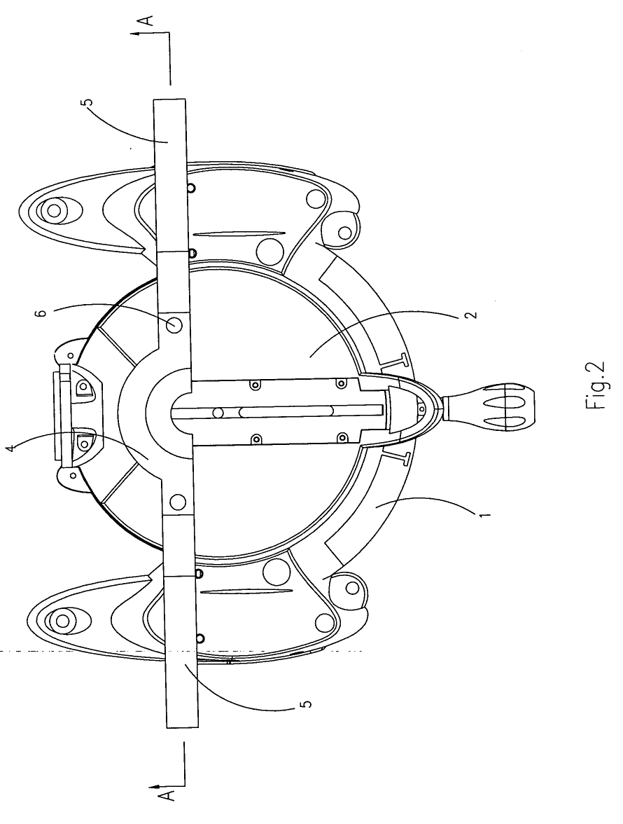

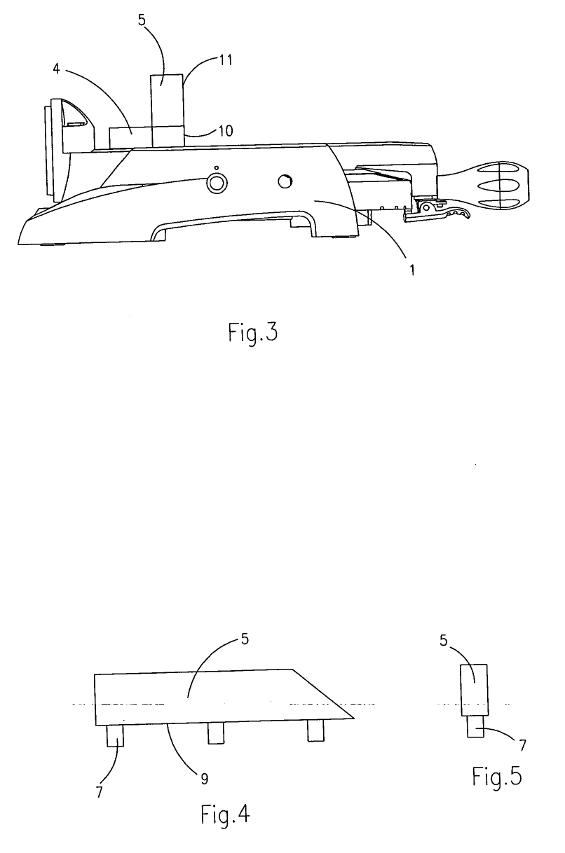

With reference to FIGS. 2 through 5, the main fence 4 supports the workpiece and the auxiliary fence 5 abuts the workpiece. The main fence 4 includes a first workpiece-abutment surface 10. The pair of auxiliary fences 5 is symmetrically mounted on the two ends of the main fence 4. Each of the pair of auxiliary fences 5 has approximately a rectangular shape and is of approximately the same thickness as the main fence 4. The auxiliary fence 5 has a second workpiece-abutment surface 11 located in the same plane as the first workpiece-abutment surface 10.

The main fence 4 comprises at least one female connecting member 6. The auxiliary fence 5 includes at least one male connecting part 7 so as to selectively interconnect to the female connecting member 6. The female connecting member 6 is a recess disposed on the top surface 8 of the main fence 4, while the male connecting part 7 is a bolt projecting downwardly from the bottom surface 9 of the auxiliary fence 5 so as to be inserted into the recess. The male connecting part 7 has approximately the same depth and diameter as the female connecting member 6.

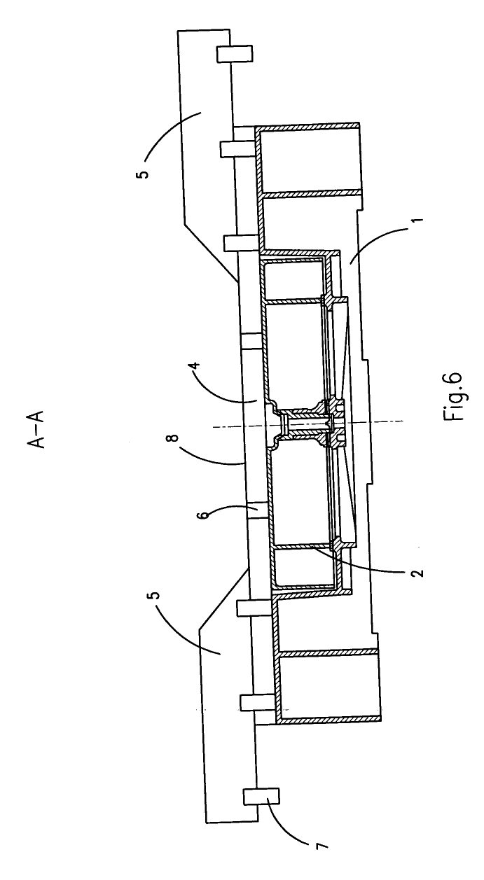

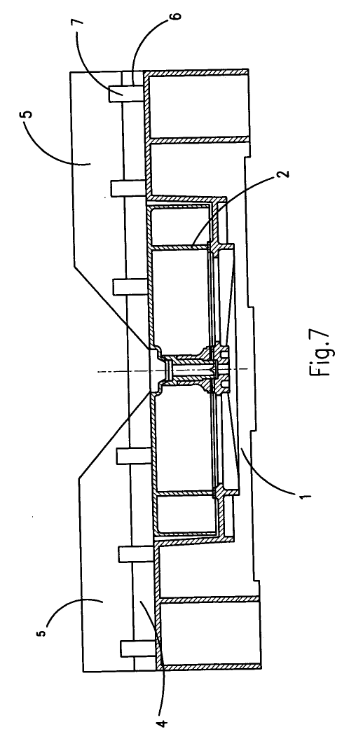

Referring to FIG. 7, when the miter saw performs square cutting, the auxiliary fences 5 are inserted into female connecting members 6 which are close to the saw assembly 3 so that the auxiliary fences 5 are close to the saw assembly 3 to provide sufficient support for the workpiece. When the miter saw performs angular cutting, the auxiliary fences 5 can be pulled out and inserted into female connecting members 6 which are further from the saw assembly 3 so that the auxiliary fences 5 are also further from the saw assembly 3 (as shown in FIGS. 1 and 6). In either case, interference with the saw assembly 3 is avoided and safe and stable cutting is facilitated.

What is claimed is:

1. A miter saw for cutting a workpiece comprising:
a base;
a worktable which is pivotally mounted axially on the base, the worktable defining a rotary support surface for supporting the workpiece;
a saw assembly pivotally connected substantially tangentially to the worktable, the saw assembly including a cutting element which is pivotal along a path between a cutting position at the support surface and a non-cutting position remote from the support surface;
a main fence fixed to the base and straddling the worktable, wherein the main fence includes a first workpiece-abutment surface and a connecting member; and
an auxiliary fence including a second workpiece-abutment surface and a connecting part interengaged with the connecting member whereby the main fence and the auxiliary fence are juxtaposed so that the first workpiece-abutment surface and the second workpiece-abutment surface are substantially coplanar and define a gap through which the path between the cutting position and the non-cutting position extends uninterrupted.

2. The miter saw of claim 1 wherein the connecting member is one of a plurality of connecting members, wherein more than one of the plurality of connecting members is selectively interengageable with the connecting part so that the first workpiece-abutment surface and the second workpiece-abutment surface define a variable gap.

3. The miter saw of claim 1 wherein the connecting part is one of a plurality of connecting parts, wherein more than one of the plurality of connecting parts is selectively interengageable with the connecting member so that the first workpiece-abutment surface and the second workpiece-abutment surface define a variable gap.

4. The miter saw of claim 1 wherein the connecting member is one of a plurality of connecting members and the connecting part is one of a plurality of connecting parts, wherein each of more than one of the plurality of connecting members is selectively interengageable with each of more than one of the connecting parts so that the first workpiece-abutment surface and the second workpiece-abutment surface define a variable gap.

5. The miter saw of claim 1 wherein the connecting part is a male connecting part and the connecting member is a female connecting member.

6. The miter saw of claim 5 wherein the female connecting member is a recess disposed on the top surface of the main fence.

7. The miter saw of claim 6 wherein the male connecting part is a fastener projecting downwardly from the base of the auxiliary fence and inserted into the corresponding recess.

8. The miter saw of claim 7 wherein the fastener is of approximately the same diameter as the recess.

9. The miter saw of claim 1 wherein the gap is a truncated V-shaped gap.

10. A miter saw comprising
a base,
a worktable pivotally mounted on the base,
a saw assembly pivotally connected to the worktable,
a main fence fixedly connected to the base and straddling the worktable and
an auxiliary fence,
the main fence includes a first workpiece-supporting surface, the auxiliary fence includes a second workpiece-supporting surface coplanar with the first workpiece-supporting surface wherein the main fence comprises at least one female connecting member, the auxiliary fence includes at least one male connecting members, the male connecting member is selectively interconnected with the female connecting member.

11. The miter saw of claim 10 wherein the female connecting member is a recess disposed on the top surface of the main fence.

12. The miter saw of claim 11 wherein the male connecting member is a bolt projecting downwardly from the bottom surface of the auxiliary fence so as to be inserted into the corresponding recess.

13. The miter saw of claim 12 wherein the bolt is of approximately the same diameter as the recess.
